(19) United States
(12) Patent Application Publication
(10) Pub. No.: US 2009/0035712 A1
(43) Pub. Date: Feb. 5, 2009

(54) Reheat Furnace System with Reduced Nitrogen Oxides Emissions

(76) Inventors: Paul D. Debski, Pittsburgh, PA (US); David Gilbert, Venetia, PA (US)

Correspondence Address: PHILIP O. POST;INDEL, INC., PO BOX 157, RANCOCAS, NJ, 08073, US

(21) Appl. No.: 11/831,997

(22) Filed: Aug. 1, 2007

(51) Int. Cl. F27B 15/10

(52) U.S. Cl. 432/1; 432/14

(57) ABSTRACT

A reheat furnace system and heating process is provided. A hydrocarbon fuel and steam mix is supplied to a chemical recuperator that uses heat from the waste gas of the reheat furnace to produce preheated reformed fuel to the burners of the reheat furnace. The steam may be supplied from a waste heat boiler.

### CROSS REFERENCE TO RELATED APPLICATIONS

Not applicable.

### FIELD OF THE INVENTION

The present invention relates to a reheat furnace system and heating process wherein furnace burners are supplied with preheated reformed fuel from a chemical recuperator.

### BACKGROUND OF THE INVENTION

FIG. 1 diagrammatically illustrates typical reheat furnace 10 comprising unfired (preheat) region 12, heat zone 14 and soak zone 16. The term “reheat” derives from the use of the furnace, namely the heating of metal product 90 passing through the furnace prior to plastic working or heat treatment of the product. The metal product may be, for example, in the form of slabs, blooms, or tubes and rods that enter through charge opening 11 in charge wall 13 of the furnace, and move sequentially through the unfired region, heat zone and soak zone on a suitable conveyance apparatus (not shown in the figure), and exit through discharge opening or door 15 in discharge wall 17 of the furnace.

Combustion air and fuel are mixed and burned in one or more burners 18 that are provided at least in the heat zone. The particular non-limiting arrangement of furnace burners shown in FIG. 1, that is, multiple burners above and below product 90 in the heat zone, and multiple burners across the width of the discharge wall in the soak zone, can be referred to as a reheat furnace with three controlled temperature zones since control of the burners in the top and bottom of the heat zone, and in the soak zone, provides a means for controlling the temperatures in each of these three regions of the furnace. In the present non-limiting example of a reheat furnace, while lintel 19 provides physical separation between the soak and heat zones, there is no structural separation between the unfired region and the heat zone; generally, the heat zone will extend approximately 1 foot towards the charge wall from the heat zone burner closest to the unfired region since this typically represents the furnace boundary at which the temperature is controllable within a required temperature range by control of the burners in the heat zone. Products of combustion radiate heat to the metal product in the unfired region of the furnace and spent products of combustion exit the furnace via flue 20.

A conventional (standard) recuperator (that is, a gas-to-gas heat exchanger) can be used with a reheat furnace to provide preheated combustion air from the flue gases. FIG. 2(a) diagrammatically illustrates reheat furnace 10a with conventional recuperator 22 located in the waste gas flue between the furnace and the stack. In this example the reheat furnace with conventional recuperator is operated for a product (example product) throughput rate of 140 tons per hour (tph) where the example product comprises a steel billet 5.5 inches square in cross section and 32 feet in length, with a cold (ambient) furnace entry temperature (approximately 72° F.) and a cross sectional average discharge temperature (at the discharge door) of 2,200° F. To achieve this production rate at steady state with a natural gas (methane) supply rate of 154,000 cubic feet per hour at standard conditions (SCFH) to burners having an adiabatic flame temperature of approximately 2,394° K in the heat and soak zones, reheat furnace 10a must have an effective length of approximately 79 feet, which results in a flue gas temperature of approximately 1,450° F. to conventional recuperator 22 for a preheated combustion air temperature of approximately 1,125° F. to the burners, with a combustion efficiency of approximately 77 percent. The effective length of the furnace, L_{f}, in FIG. 1, is typically defined as the distance from the inside of the charge wall to the centerline of the discharge door. Furnace width is typically limited to the required width of product moving through the furnace while furnace height is typically limited to space required for installation of the burners.

FIG. 2(b) graphically illustrates the heating curve (line A) of the average cross sectional temperature of the example product as it passes through the furnace, with reference to the top (line B) and bottom (line C) furnace temperatures, and FIG. 2(c) is the heat balance diagram associated with the heating curve for the example product in FIG. 2(b). For this example waste gas adiabatic equilibrium NOx concentration can be calculated as approximately 5,890 parts per million (ppm).

While a reheat furnace with a conventional recuperator can be beneficial from an energy conservation perspective, excessive emission of nitrogen oxides, generally referred to as NOx, can result from operation of such reheat furnace. Therefore one object of the present invention is to provide a reheat furnace with reduced NOx emissions without decreasing the combustion efficiency of an equivalent (that is, identical product throughput) reheat furnace with conventional recuperation.

### BRIEF SUMMARY OF THE INVENTION

In one aspect the present invention is a reheat furnace system and heating process wherein a mix of hydrocarbon fuel, such as methane, and steam are supplied to a chemical recuperator. Heated flue gas from the reheat furnace is supplied to the chemical recuperator to react the hydrocarbon fuel with the steam to form a preheated reformed fuel including carbon monoxide. The preheated reformed fuel is supplied to and combusted in the burners of the reheat furnace. The steam can be supplied from a waste heat boiler heated by flue gas from the reheat furnace.

The above and other aspects of the invention are set forth in this specification and the appended claims.

### BRIEF DESCRIPTION OF THE DRAWINGS

The foregoing brief summary, as well as the following detailed description of the invention, is better understood when read in conjunction with the appended drawings. For the purpose of illustrating the invention, there is shown in the drawings exemplary forms of the invention that are presently preferred; however, the invention is not limited to the specific arrangements and instrumentalities disclosed in the following appended drawings:

FIG. 1 is a simplified cross sectional diagram of a typical reheat furnace.

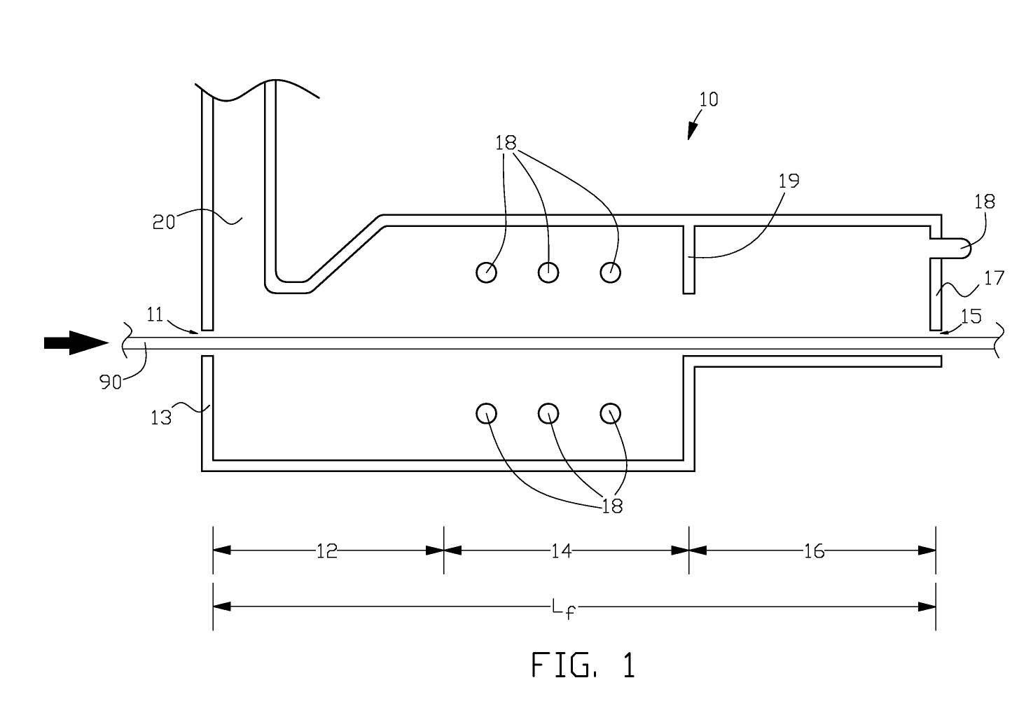

FIG. 2(a) is a diagrammatic representation of a heating process for a reheat furnace with conventional recuperation.

FIG. 2(b) is a product heating curve for the heating process illustrated in FIG. 2(a).

FIG. 2(c) is a heat balance diagram for the product heating curve shown in FIG. 2(b).

FIG. 3(a) is a diagrammatic representation of one example of a heating process for a reheat furnace system of the present invention.

FIG. 3(b) is a product heating curve for the heating process illustrated in FIG. 3(a).

FIG. 3(c) is a heat balance diagram for the product heating curve shown in FIG. 3(b).

FIG. 4(a) is a diagrammatic representation of a heating process for a reheat furnace with a combination of conventional and chemical recuperation.

FIG. 4(b) is a product heating curve for the heating process illustrated in FIG. 4(a).

FIG. 4(c) is a heat balance diagram for the product heating curve shown in FIG. 4(b).

### DETAILED DESCRIPTION OF THE INVENTION

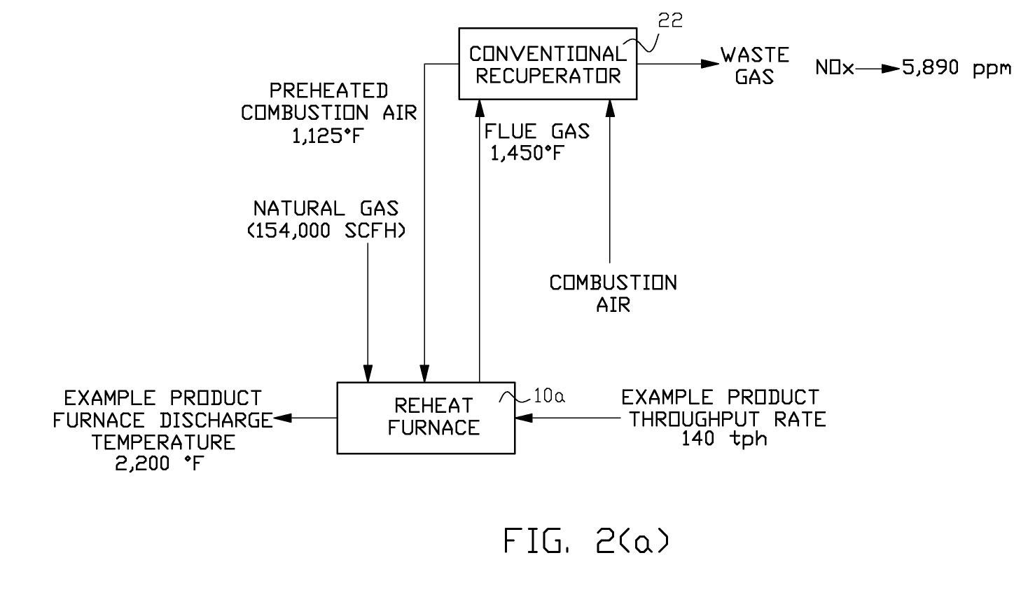

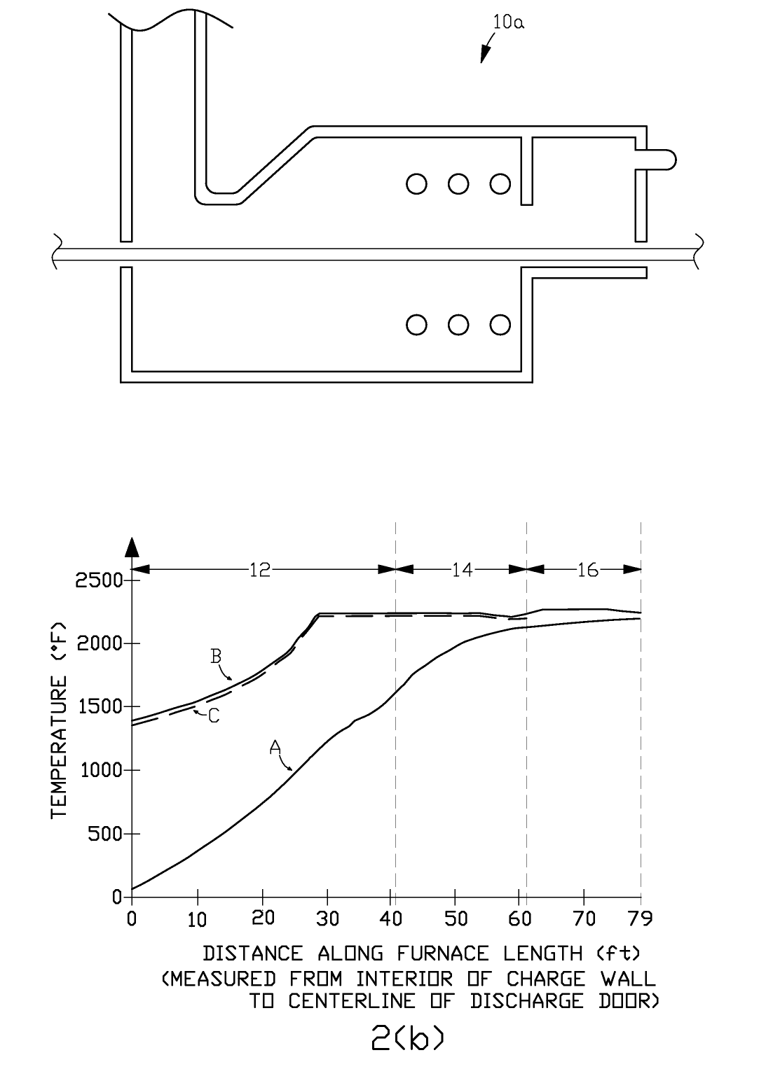

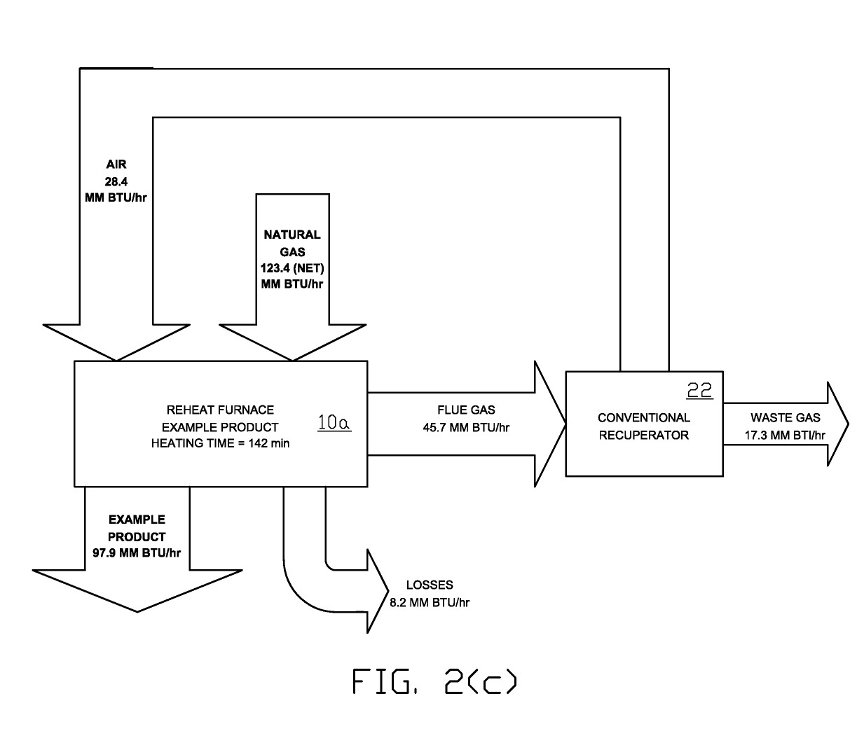

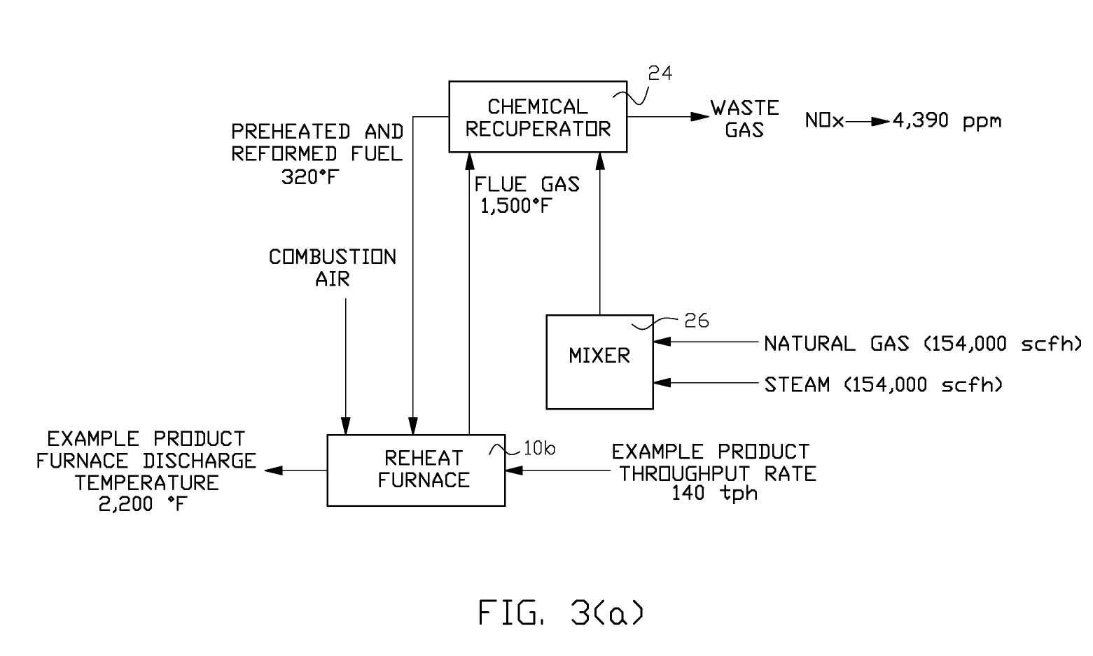

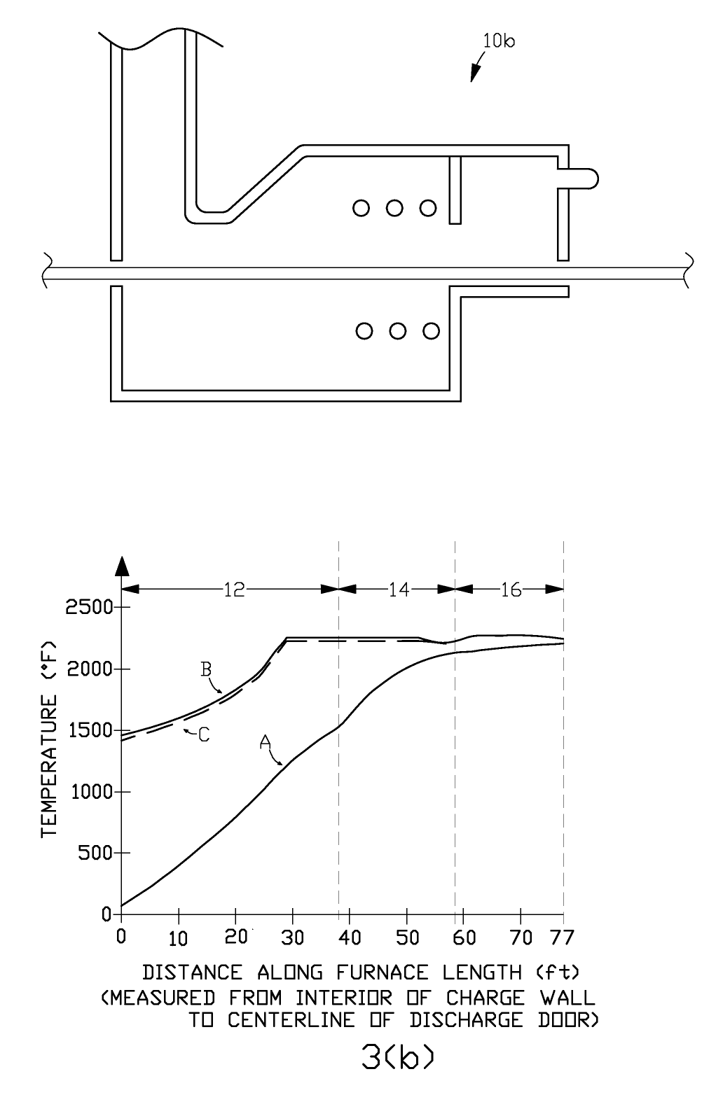

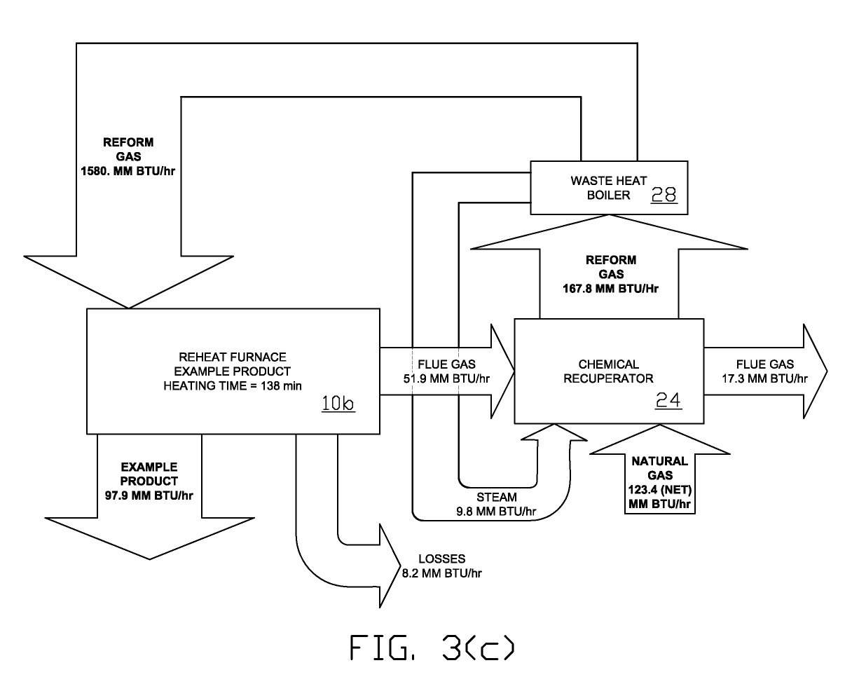

FIG. 3(a) diagrammatically illustrates one non-limiting example of a reheat furnace system and heating process of the present invention. Chemical recuperator 24 is located in the waste gas flue between reheat furnace 10b and the stack, for example, but not by way of limitation, at a flue length of approximately 10 feet from the furnace. The heating process in this example will provide a product throughput rate of 140 tons per hour, which is the same as the rate for the previously described prior art reheat furnace with conventional recuperator. In steady state operation, reheat furnace 10b supplies flue gas at approximately 1,500° F. to chemical recuperator 24. Hydrocarbon fuel, for example, methane (natural gas) and steam are supplied to mixer 26, which supplies the methane/steam mix to the chemical recuperator. In this non-limiting example the natural gas and steam are supplied at approximately the same rate, namely 154,000 SCFH. In other examples of the invention the ratio of supplied hydrocarbon fuel and steam may vary independently of each other depending upon the hydrogen content of the fuel and/or the properties of the supplied steam. The heated flue gas supports reaction of the hydrocarbon fuel with the steam to primarily produce preheated (approximately 320° F. in this example) hydrogen-enriched (reformed) fuel and carbon monoxide, which is delivered to one or more furnace burners that have an adiabatic flame temperature of approximately 2,295° K and are located in at least the heat zone of a reheat furnace. This relatively low flame temperature associated with cooler combustion air assists in reducing NOx waste gas emissions from the furnace while the enriched reformed fuel burns at a relatively high efficiency. In this example the waste gas adiabatic equilibrium NOx concentration can be calculated as approximately 4,390 ppm, which is 1,500 ppm less than the same concentration for the above example of a reheat furnace with a conventional recuperator operating at process conditions to produce the same product throughput with the same combustion efficiency of approximately 77 percent. An added benefit of the reheat furnace system of the present invention is reduction in the effective length of the furnace (from approximately 79 feet to 77 feet) over the comparative reheat furnace with conventional recuperator as illustrated in FIG. 3(b) and FIG. 2(b), respectively, to achieve the desired minimum flue gas temperature (typically 1,500° F.) for operation of the chemical recuperator.

In the above example of the invention the adiabatic equilibrium NOx concentration of 4,390 ppm represents an approximately 75 percent reduction in NOx concentration of the comparative prior art example described above. Typically, but not by way of limitation, the reheat furnace system and heating process of the present invention will achieve an adiabatic equilibrium NOx concentration in the approximate range of 4,700 to 4,100 ppm.

FIG. 3(b) graphically illustrates the heating curve (line A) of the average cross sectional temperature of the example product as it passes through the reheat furnace 10b, with reference to the top (line B) and bottom (line C) furnace temperatures, and FIG. 3(c) is the heat balance diagram associated with the heating curve for the example product in FIG. 3(b).

In the above example of the invention the described chemical reformation process is achieved after the flue gas input to chemical recuperator 24 reaches a minimum temperature. Heating the reheat furnace and flue gas to the requisite minimum temperature can be achieved by supplying the hydrocarbon fuel, without steam, to chemical recuperator 24, which delivers the hydrocarbon fuel to the burners of reheat furnace 10b without reformation. Upon reaching the required minimum flue gas temperature to sustain chemical reformation, steam, in addition to the hydrocarbon fuel, can be supplied to the chemical recuperator as described above for steady state operation. In other examples of the invention hydrocarbon fuel may be supplied directly to the furnace burners until the minimum flue gas temperature that is required to sustain chemical reformation is reached, at which time, the direct fuel supply can be removed and the steady state chemical reformation process can be used as described above.

In FIG. 3(c) steam is supplied to chemical recuperator 24 via waste heat boiler 28, which is located downstream of the chemical recuperator in the reformed fuel stream to utilize sensible heat in the stream for producing steam in the boiler from a suitable source of water. In other examples of the invention the boiler may be located downstream of the chemical recuperator in the flue gas stream to utilize sensible heat in the stream for the production of steam. Further steam may be supplied to the chemical recuperator by any other suitable method including a boiler fueled by a separate source of energy.

The term “chemical recuperator” as used herein, refers to an apparatus that reforms a mixture of hydrocarbon-rich fuel and steam into a preheated hydrogen-enriched fuel and carbon monoxide in an endothermic reaction supported by heated flue gas. Hence the apparatus is sometimes described as a reformer. One suitable, but non-limiting, example of a chemical reformer for use with one example of the reheat furnace and heating process of the present invention is model RS1069 available from Thermal Transfer Corporation, Duquesne, Pa., UNITED STATES.

A suitable but non-limiting example of a mixer for use with one example of the reheat furnace with chemical recuperation of the present invention is model MR-500-166 available from Maxon Corporation, Muncie, Ind., UNITED STATES, which can be adopted for steam/hydrocarbon fuel mixing.

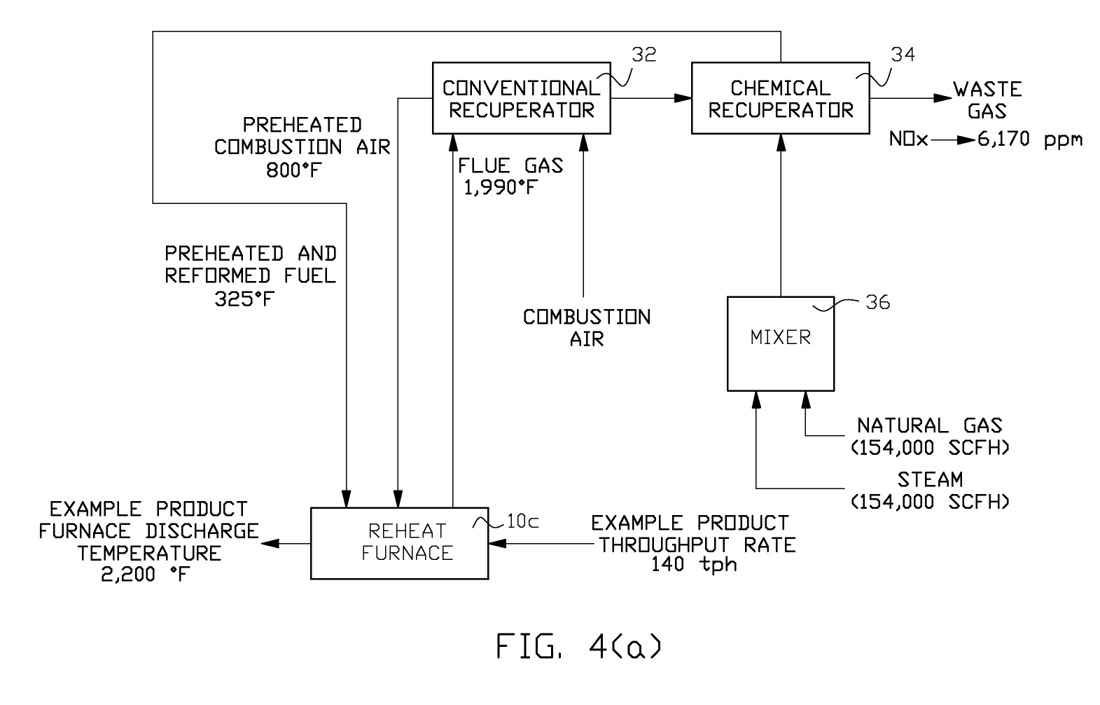

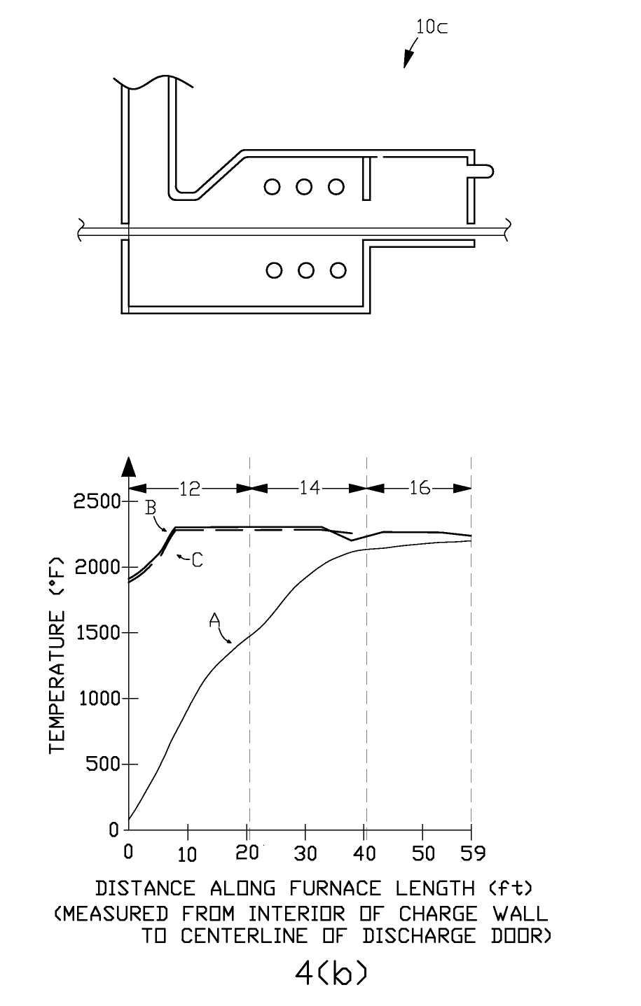

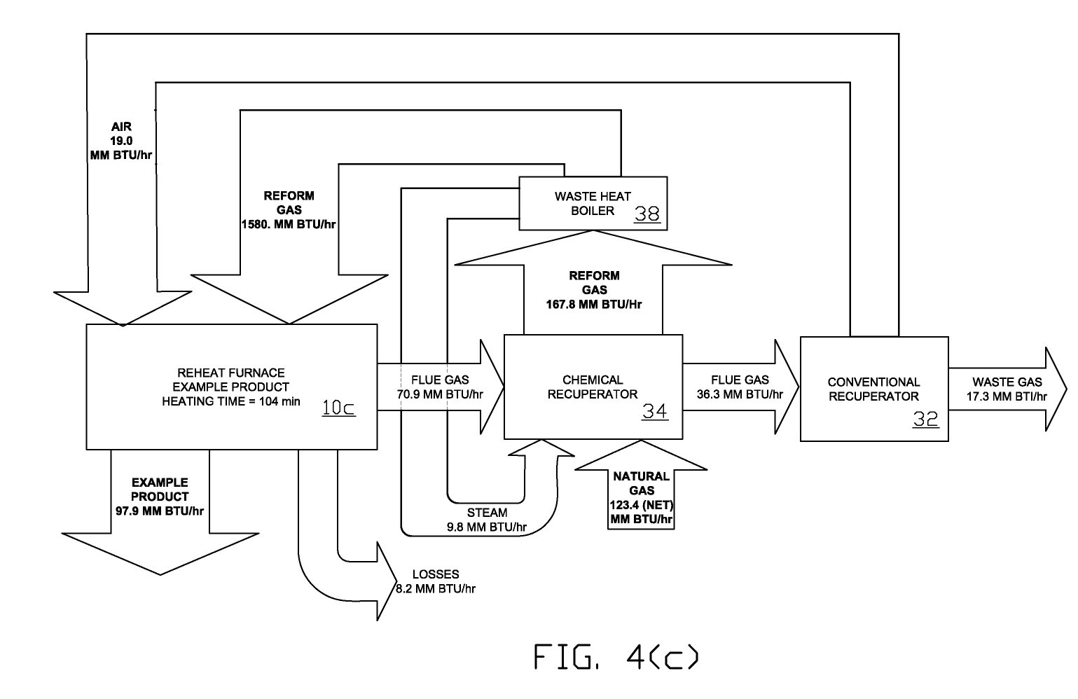

In comparison with the reheat furnace system and heating process of the present invention, FIG. 4(a) diagrammatically illustrates a comparable reheat furnace arrangement with a combination of both conventional recuperation and chemical recuperation that maintains the same production rate, namely 140 tons of example product per hour with a product temperature of 2,200° F. at discharge from the furnace and a combustion efficiency of approximately 77 percent. To achieve this production rate at steady state with methane and steam supply rates of 154,000 SCFH to mixer 36, reheat furnace 10c has an effective length of 55 feet, which results in a flue gas temperature of approximately 1,990° F. to conventional recuperator 32 for a preheated combustion air temperature of approximately 800° F. being supplied to the furnace burners. Chemical recuperator 34 is located downstream of the conventional recuperator with input of flue gas at approximately 1,500° F. to output a preheated (approximately 325° F.) reformed fuel that is supplied to the furnace burners, which have an adiabatic flame temperature of approximately 2,442° K. In this example the waste gas adiabatic equilibrium NOX concentration can be calculated as approximately 6,170 ppm, which is significantly greater than the concentration achieved with the reheat furnace system and heating process of the present invention.

The present invention is not limited by the type, quantity and arrangements of burners used in the reheat furnace and heating process of the present invention since one skilled in the art can practice the claimed invention by varying the type, quantity or arrangement of burners for a particular application. Further although the above examples of the reheat furnace and heating process of the present invention utilize one unfired region and one heat zone and soak zone, other arrangements and quantities of zones can be used in a reheat furnace and heating process of the present invention. While the above examples of the invention use methane (natural gas), other types of hydrocarbon fuels may be used in other examples of the invention.

Adiabatic equilibrium NOx concentrations referred to as “parts per million (ppm)” in this specification is defined as parts per million by volume on a wet basis with one (1) percent oxygen in the flue (waste) gas of the reheat furnace. Adiabatic equilibrium NOx concentrations determined with other reference parameters can be converted to equivalent adiabatic equilibrium NOx concentrations in parts per million by volume on a wet basis with one (1) percent oxygen in the flue (waste) gas of the reheat furnace by one skilled in the art.

Determination of NOx concentration can be made by any suitable method, for example, by use of a “Computer Program for Calculation of Complex Chemical Equilibrium Compositions” available from the United States National Aeronautics and Space Administration (NASA) and detailed in NASA Reference Publication 1311. The North American Combustion Handbook may be referred to for calculation of adiabatic flame temperatures, fuel compositions, combustion air temperatures, and ratios of combustion air to fuel calculations.

The above examples of the invention have been provided merely for the purpose of explanation and are in no way to be construed as limiting of the present invention. While the invention has been described with reference to various embodiments, the words used herein are words of description and illustration, rather than words of limitations. Although the invention has been described herein with reference to particular means, materials and embodiments, the invention is not intended to be limited to the particulars disclosed herein; rather, the invention extends to all functionally equivalent structures, methods and uses. Those skilled in the art, having the benefit of the teachings of this specification, may effect numerous modifications thereto, and changes may be made without departing from the scope and spirit of the invention in its aspects.

1. A method of combusting fuel in the burners of a reheat furnace, the method comprising the steps of:
supplying a mix of a hydrocarbon fuel and steam to a chemical recuperator;
supplying the flue gas from the reheat furnace to the chemical recuperator to react the hydrocarbon fuel with the steam to form a preheated reformed fuel; and
combusting the reformed heated fuel in the burners of the reheat furnace.

2. The method of claim 1 further comprising the steps of providing the reheat furnace with at least one unfired region, at least one heat zone and at least one soak zone; providing each of the at least one heat zone with at least one burner; and providing at least one of the at least one soak zone with at least one burner.

3. The method of claim 1 further comprising the step of adjusting the ratio of hydrocarbon fuel and steam to the chemical recuperator responsive to the hydrogen content of the hydrocarbon fuel or the properties of the steam.

4. The method of claim 1 further comprising the step of supplying the steam from a waste heat boiler heated with sensible heat from the reformed fuel stream or the flue gas from the reheat furnace.

5. A method of heating a metal product in a reheat furnace, the method comprising the steps of:
supplying a mix of a hydrocarbon fuel and steam to a chemical recuperator;
supplying the flue gas from the reheat furnace to the chemical recuperator to react the hydrocarbon fuel with the steam to form a preheated reformed fuel;
combusting the preheated reformed fuel in the burners of the reheat furnace; and
conveying the metal product through the reheat furnace.

6. The method of claim 5 further comprising the steps of providing the reheat furnace with at least one unfired region, at least one heat zone and at least one soak zone; providing each of the at least one heat zone with at least one burner; and providing at least one of the at least one soak zone with at least one burner.

7. The method of claim 5 further comprising the step of adjusting the ratio of hydrocarbon fuel and steam to the chemical recuperator responsive to the hydrogen content of the hydrocarbon fuel or the properties of the steam.

8. The method of claim 5 further comprising the step of supplying the steam from a waste heat boiler heated with sensible heat from the reformed fuel stream or the flue gas from the reheat furnace.

9. A reheat furnace system for heating a metal product, the reheat furnace system comprising:
a reheat furnace having one or more burners located in at least one heat zone of the reheat furnace;
a chemical recuperator disposed in the flue of the furnace, the chemical recuperator having an output of preheated reformed fuel supplied to the one or more burners;
a source of hydrocarbon fuel supplied to the chemical recuperator; and
a source of steam supplied to the chemical recuperator.

10. The reheat furnace system of claim 9 further comprising an unfired region upstream of the at least one heat zone and a soak zone downstream of the at least one heat zone.

11. The reheat furnace system of claim 10 further comprising at least one burner located in the soak zone.

12. The reheat furnace system of claim 10 further comprising a controller for adjusting the ratio of hydrocarbon fuel and steam to the chemical recuperator responsive to the hydrogen content of the hydrocarbon fuel or the properties of the steam.

13. The reheat furnace system of claim 10 further comprising a waste heat boiler disposed in the reformed fuel stream or the flue of the furnace to supply the source of steam.

14. A method of operating a reheat furnace, the method comprising the steps of:
increasing the temperature of the flue gas from the reheat furnace to approximately 1,500 degrees Fahrenheit to form a heated flue gas;
supplying a mix of hydrocarbon fuel and steam to a chemical recuperator;
supplying the heated flue gas to the chemical recuperator to react the mix of hydrocarbon fuel and steam and form a preheated reformed fuel; and
supplying the preheated reformed fuel to the burners of the reheat furnace.

15. The method of claim 14 wherein the step of increasing the temperature of the flue gas comprises supplying the hydrocarbon fuel to the burners of the reheat furnace via the chemical recuperator.

16. The method of claim 14 wherein the step of increasing the temperature of the flue gas comprises supplying the hydrocarbon fuel directly to the burners of the reheat furnace.

17. The method of claim 14 further comprising the step of adjusting the mix of the hydrocarbon fuel and steam supplied to the chemical recuperator responsive to a change in the hydrogen content of the hydrocarbon fuel.

18. The method of claim 14 further comprising the step of adjusting the mix of the hydrocarbon fuel and steam supplied to the chemical recuperator responsive to a change in the properties of the steam.

19. A method of providing a reheat furnace system supplied with a hydrocarbon fuel, the method comprising the steps of:
supplying a mix of the hydrocarbon fuel and steam to a chemical recuperator;
supplying the flue gas from the reheat furnace to the chemical recuperator to react the hydrocarbon fuel with the steam to form a preheated reformed fuel; and
combusting the preheated reformed fuel in the burners of the reheat furnace for a waste gas adiabatic equilibrium NOx concentration no greater than the equivalent of 4,700 parts per million by volume on a wet basis of one (1) percent oxygen in the flue gas.

20. The method of claim 19 wherein the waste gas adiabatic equilibrium NOx concentration is in the approximate range of the equivalent of 4,100 to 4,700 parts per million by volume on a wet basis of one (1) percent oxygen in the flue gas.
